(19) United States
(12) Patent Application Publication
(10) Pub. No.: US 2008/0101241 A1
(43) Pub. Date: May 1, 2008

(54) Ethernet OAM at intermediate nodes in a PBT network

(75) Inventors: Dinesh Mohan, Kanata (CA); Christopher Monti, Tyngsboro, MA (US); Piotr Romanus, Andover, MA (US); David Tsang, Sudbury, MA (US); Michael Chen, Chapel Hill, NC (US)

Correspondence Address: JOHN C. GORECKI, ESQ., P.O BOX 553, CARLISLE, MA, 01741, US

(73) Assignee: Nortel Networks Limited, St. Laurent (CA)

(21) Appl. No.: 11/724,981

(22) Filed: Mar. 16, 2007

Related U.S. Application Data
(60) Provisional application No. 60/855,550, filed on Oct. 31, 2006.

(51) Int. Cl. H04L 12/26

(52) U.S. Cl. 370/236.2; 370/392

(57) ABSTRACT

OAM may be implemented at an intermediate node on a PBT trunk in an Ethernet network by causing OAM frames to be addressed to the PBT trunk endpoint but causing the OAM frames to carry an indicia (Ether-type, OpCode, TLV value or combination of these and other fields) that the OAM frames are intended to be used for intermediate node OAM functions. The Ether-type, OpCode, and TLV values may be standardized values, or vendor specific values such as OpCode=51 or TLV=31 may be used. Addressing the OAM frames to the PBT trunk end point enables the OAM frames to follow the PBT trunk through the network. The OAM indicia signals to the intermediate nodes that the OAM frames are intended to be used to perform an intermediate node OAM function. The OAM frames may contain reverse trunk information to prevent the intermediate nodes from being required to store correlation between forward and reverse PBT trunks.

### CROSS REFERENCE TO RELATED APPLICATIONS

This application is related to and claims the benefit of U.S. Provisional Application No. 60/855,550, filed Oct. 31, 2006, entitled “OAM For Differential Forwarding in Address Based Networks,” the content of which is hereby incorporated herein by reference.

### BACKGROUND OF THE INVENTION

1. Field of the Invention

The present invention relates to communication networks and, more particularly, to a method and apparatus for implementing Ethernet OAM at intermediate nodes in a Provider Bridged Transport (PBT) network.

2. Description of the Related Art

Data communication networks may include various routers, switches, bridges, hubs, and other network devices coupled to and configured to pass data to one another. These devices will be referred to herein as “network elements.” Data is communicated through the data communication network by passing protocol data units, such as Internet Protocol (IP) packets, Ethernet Frames, data cells, segments, or other logical associations of bits/bytes of data, between the network elements by utilizing one or more communication links between the devices. A particular Protocol Data Unit (PDU) may be handled by multiple network elements and cross multiple communication links as it travels across the network.

The various network elements on the communication network communicate with each other using predefined sets of rules, referred to herein as protocols. Different protocols are used to govern different aspects of communications on a network, such as how signals should be formed for transmission between network elements, various aspects of what the protocol data units should look like, how packets should be handled or routed through the network by the network elements, and how information associated with routing information should be exchanged between the network elements.

Ethernet is a well known networking protocol that has been defined by the Institute of Electrical and Electronics Engineers (IEEE) as standard 802. Originally Ethernet was used on local area networks, such as enterprise networks in businesses and on college campuses. Changes in the Ethernet standard have enabled Ethernet to evolve to the point where Ethernet is now being considered for larger networks such as metropolitan area and wide area networks.

One of the enhancements that has enabled Ethernet to be used in larger, carrier networks, is the ability of Ethernet to support Operation, Administration, and Maintenance (OAM) functions desired by the network providers. OAM functions such as connectivity check, loopback, trace route, and alarm indication signals need to be implemented to enable network providers to be able to determine if the network is operating correctly and to diagnose/isolate faults when faults occur on the network.

Ethernet traditionally was developed as a best efforts technology. However, as Ethernet is adapted to carrier networks it has become desirable to be able to engineer the network. Specifically, carriers may want to create paths between end points on the network such that they are able to know the path particular packets will take through the network. One example of a technology that is being developed in connection with this is referred to as Provider Bridged Transport (PBT). PBT is related to IEEE 802.1ah and is being discussed as Provider Backbone Bridges—Traffic Engineering (PBB-TE) activity. PBT is described in greater detail in U.S. patent application Ser. No. 10/818,685, entitled Traffic Engineering in Frame-Based Carrier Networks”, the content of which is hereby incorporated herein by reference.

FIG. 1 illustrates an example network 100 in which a number of Ethernet switches 102 are interconnected via links 104. Provider bridged trunks 106 may be defined as flows of traffic having a particular VLAN ID (VID) and Destination MAC Address (DA). In PBT, the paths through the network are referred to as trunks or tunnels, and may be considered to be similar to MPLS tunnels. As used herein, the term “trunk” will be used to describe a PBT path. Typically, a network management station defines the trunks that are to be created through the network, and the trunks are then established on the network elements either by configurations directly from the network management station or using a signaling protocol. The network management station may design the trunks to engineer the flows of data on the network in a manner known in the art. Additionally, trunks may be set up automatically via the exchange of routing information by the network elements if desired. The combination of a VLAN ID (VID) tag with a particular destination MAC Address (DA) will uniquely identify a particular trunk, so that network elements on the network may forward traffic based on VID/DA. Signaling of the trunks will cause intermediate network elements to install a forwarding entry into their FIB for the VID/DA so that frames having the particular VID/DA combination will be forwarded along the path from the source to the destination.

PBT Trunks are unidirectional paths through the network. Generally, two trunks are set up between a pair of nodes, one in each direction, to enable traffic to be transmitted in both directions between the nodes. For various reasons the trunks are typically set up along the same path (same set of intermediate nodes and links) however they are not required to be set up in this manner. Depending on the manner in which PBT is implemented, the forward and reverse trunks may be independent of each other, such that intermediate nodes on the trunks may not maintain a correlation of forwarding information for trunks extending in opposite directions between pairs of sources and destinations on the network.

Intermediate nodes install forwarding state for the trunks by installing an entry in their forwarding tables to indicate that frames having a particular destination Mac address (DA) and VID and which arrive over a particular port should be forwarded in a particular manner. For example, assume in FIG. 1 that there is a first trunk 106a extending from source node A to a destination node D. Intermediate node B will install forwarding state in its forwarding information base (FIB) to indicate that frames with the identified DA/VID should be forwarded to node C. Similarly, node C will install forwarding state in its FIB such that frames with the DA/VID will be forwarded to node D.

On the reverse path, the trunk will be identified with the Destination Address (DA) of node A, and a separate VID will generally be assigned to the flow of frames from node D to node A as well. Accordingly, the intermediate nodes will have a separate FIB entry for trunk 106b to enable them to forward frames on the reverse path 106b from node D to node A. To avoid FIB entries from getting too complicated, the FIB entries for the two trunks 106a, 106b are not correlated. While correlation in a network such as the one illustrated may appear to be relatively straightforward, as the network increases in size and millions of such PBT trunks are created, correlation between trunks is much less trivial. Additionally, as multicast is implemented, the reverse path trunks may be less trivially correlated.

In addition to not maintaining a correlation between forward and reverse PTB trunks, the intermediate nodes along a PBT trunk may not have information about intermediate points along the PBT trunks and thus may not know the addresses of intermediate points along the path that the trunks will take between node A and node D. Additionally, the intermediate points may be configured to only forward the frames based on DA/VID. Any frame that arrives and does not match an entry in the FIB may therefore be discarded by the network element. Thus, if a Ethernet OAM frame were to be addressed to network element C on PBT trunk 106a, upstream intermediate network element B may not have forwarding state for the frame and thus drop the frame. Accordingly, network element C may never receive the OAM frame and wouldn't therefore be able to respond to it.

The combination of a possible lack of correlation between forwarding and reverse path, and the fact that frames that are addressed to intermediate nodes will be dropped by other intermediate nodes on a the network complicates intermediate node OAM in a PBT network. Specifically, although an OAM flow may be defined end-to-end between messaging end points (MEPs) in the source A and destination D nodes, even if messaging intermediate points (MIPs) are defined in the intermediate nodes, those nodes will not process the OAM frames but rather will simply forward the OAM frames over the PBT trunk. Additionally, if the intermediate nodes are directly addressed they may not recognize the frame since the forwarding information base may not have an entry for the DA and VID associated with the intermediate node and, according to PBT, the intermediate nodes are to discard frames for which they do not contain forwarding state.

Finally, even if the intermediate node does recognize the OAM message and process the OAM message, it will not know how to reply to the OAM message since it will not have the VID that is used by the trunk in the reverse direction. Thus, any OAM reply message generated by the intermediate node would be discarded by other intermediate nodes because it would not be recognized by those nodes. Stated differently, since the intermediate node may not have a correlation between the VID used on the forward path and the VID used on the reverse path, although the intermediate node can extract the destination address to be used on the reverse path, e.g. the MAC address of A) it may not know the VID that the other intermediate nodes will use in combination with the DA on the reverse trunk 106b. Thus, the intermediate node may not be able to create a frame that will be handled by the other intermediate nodes as an ordinary frame on the reverse trunk. Thus, even if the OAM message is received and processed by an intermediate node, the intermediate node may not be able to create a reply frame that is able to be transmitted over the reverse trunk 106b. Accordingly, it would be desirable to be able to implement OAM in a PBT network.

### SUMMARY OF THE INVENTION

Intermediate nodes may be configured to recognize OAM frames on a PBT trunk and to respond to OAM frames that are addressed to PBT trunk endpoints but which contain an indication that they are to be used to implement an intermediate node OAM function. Three solutions are provided, although the invention is not limited to these particular solutions as other ways of implementing embodiments of the invention may be used as well. In a first embodiment, an EtherType value is used to identify a frame as an intermediate node OAM frame to indicate to the intermediate nodes on the PBT trunk that the OAM frame is to be processed by the intermediate nodes. According to another embodiment of the invention, an OpCode value is used to indicate to the intermediate nodes that the OAM frame is to be processed by the intermediate nodes. According to another embodiment of the invention, a Type Length Value (TLV) value is used to indicate to the intermediate nodes that the OAM frame is to be processed by the intermediate nodes.

To prevent the intermediate nodes from being required to maintain a correlation between forward and reverse trunks, the OAM frame may be configured to contain reply address information such as the DA/VID of the reverse trunk so that reply messages generated in response to the OAM frame may be passed over the reverse trunk.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a portion of an example Ethernet network in which PBT trunks may be implemented;

FIG. 2 is a block diagram of an Ethernet frame configured to implement OAM at an intermediate node of a PBT trunk using a OAM Ether-type according to an embodiment of the invention;

FIG. 3A is a block diagram of another embodiment of an Ethernet frame configured to implement OAM at an intermediate node of a PBT trunk using a new Ether-type according to an embodiment of the invention;

FIGS. 3B and 3C are block diagrams of Ethernet frames created from the Ethernet frame of FIG. 3A and configured to implement OAM reply messages by an intermediate node of a PBT trunk according to embodiments of the invention;

FIG. 4A is a block diagram of an Ethernet frame configured to implement OAM at an intermediate node of a PBT trunk using a vendor specific OpCode according to an embodiment of the invention;

FIG. 5A is a block diagram showing the relative placement and size of the fields of the Ethernet Frame of FIG. 4A in greater detail;

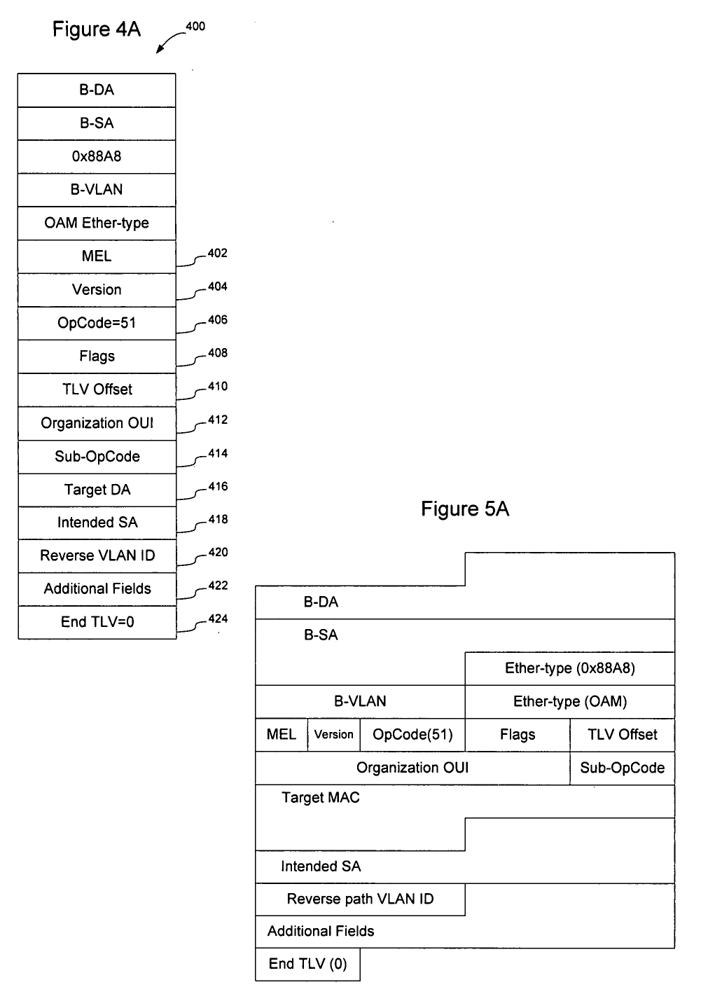

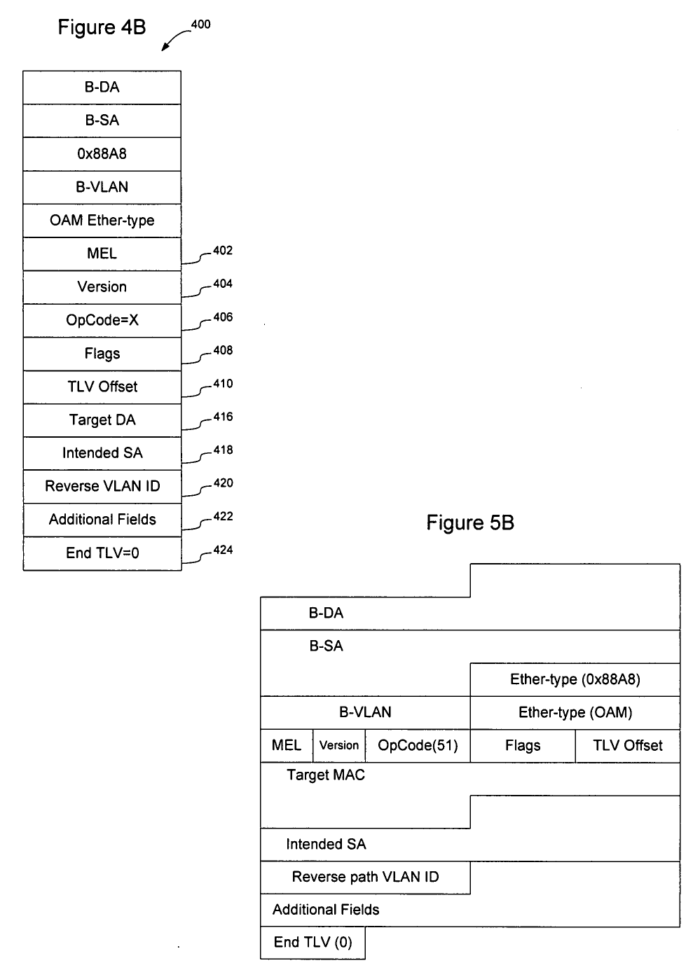

FIG. 4B is a block diagram of an Ethernet frame configured to implement OAM at an intermediate node of a PBT trunk using a standardized OpCode according to an embodiment of the invention;

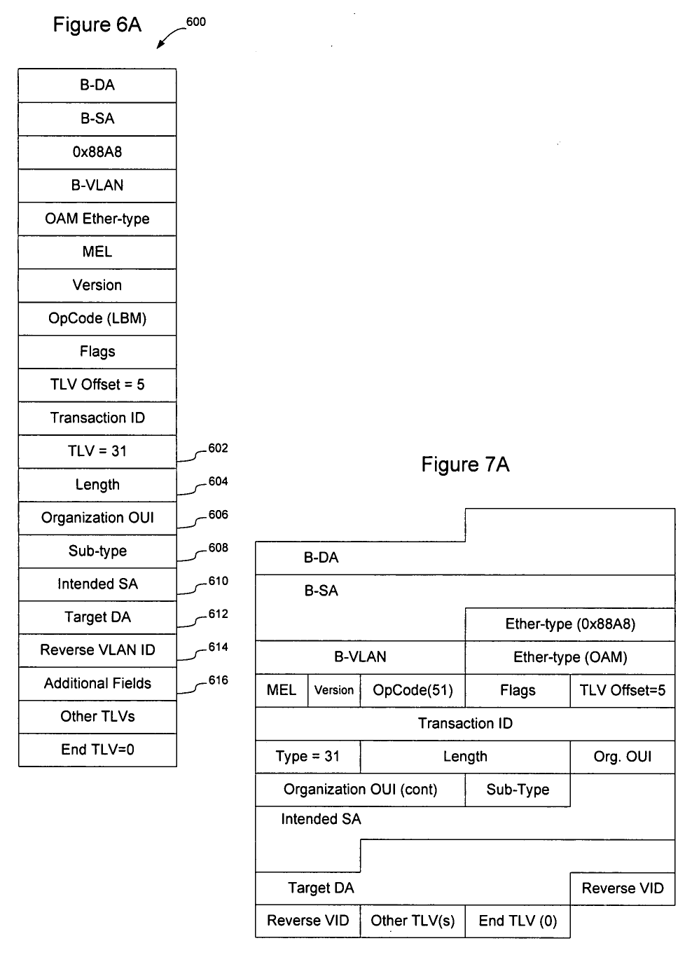

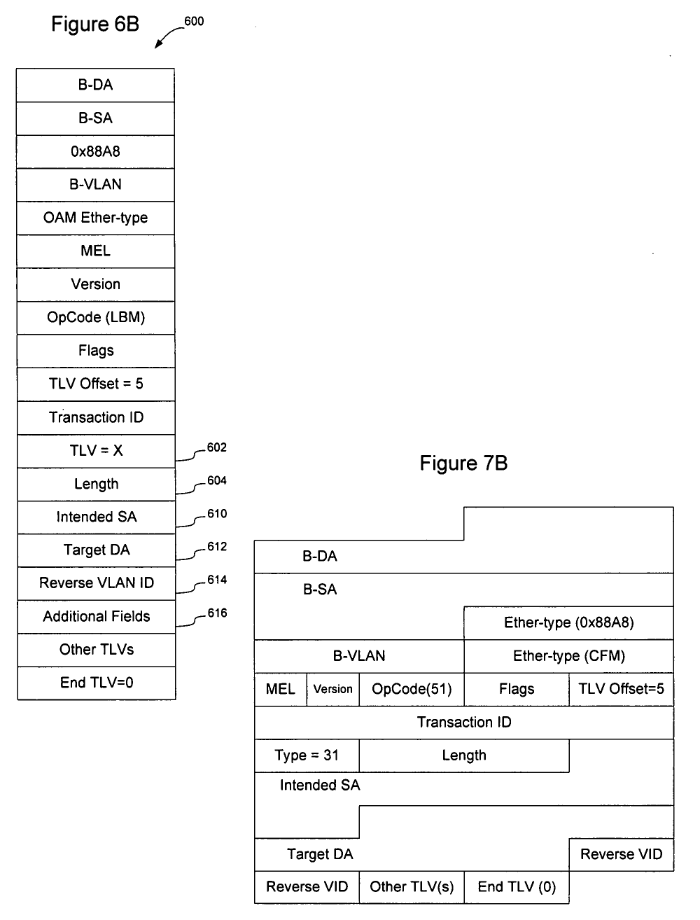

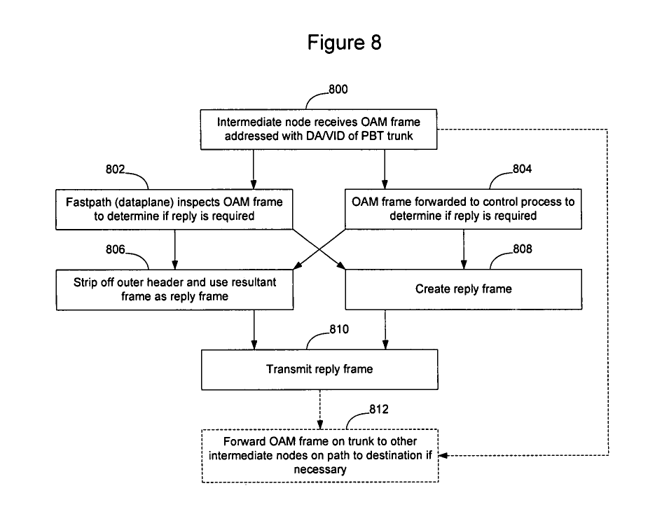

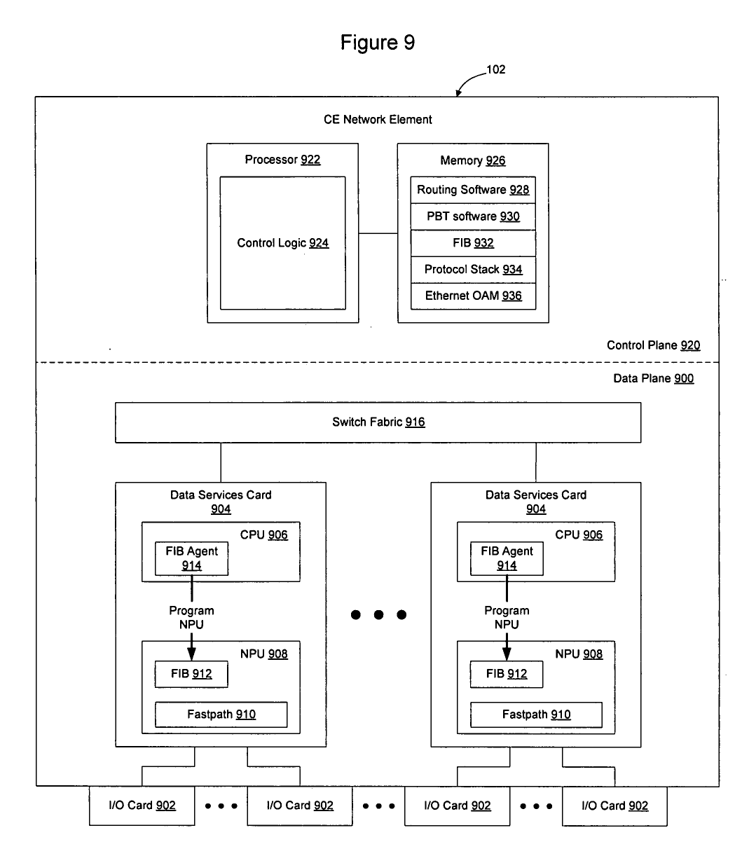

FIG. 5B is a block diagram showing the relative placement and size of the fields of the Ethernet Frame of FIG. 4B in greater detail;

FIG. 6A is a block diagram of an Ethernet frame configured to implement OAM at an intermediate node of a PBT trunk using a vendor specific TLV according to an embodiment of the invention;

FIG. 7A is a block diagram showing the relative placement and size of the fields of the Ethernet Frame of FIG. 6A in greater detail;

FIG. 6B is a block diagram of an Ethernet frame configured to implement OAM at an intermediate node of a PBT trunk using a standardized TLV according to an embodiment of the invention;

FIG. 7B is a block diagram showing the relative placement and size of the fields of the Ethernet Frame of FIG. 6B in greater detail;

FIG. 8 is a flow diagram illustrating a process that may be used to implement an embodiment of the invention; and

FIG. 9 is a functional block diagram of a network switch that may be used to implement an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

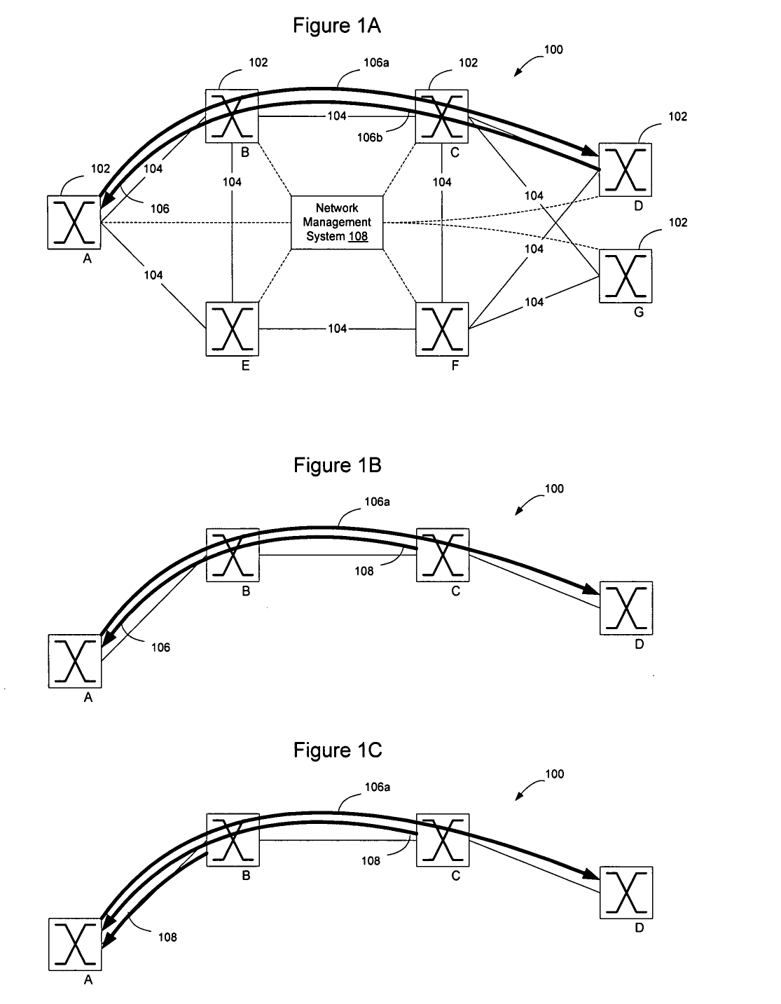

FIG. 1 shows a portion of an example Ethernet network 100 in which network elements 102 are interconnected by links 104. PBT trunks 106a, 106b may be established through the Ethernet network 100 as described in greater detail in U.S. patent application Ser. No. 10/818,685, entitled Traffic Engineering in Frame-Based Carrier Networks”, the content of which is hereby incorporated herein by reference.

PBT trunks 106 are created to extend one way though the Ethernet network 100 by causing forwarding state to be installed on intermediate nodes that will cause the intermediate nodes to forward traffic with the trunk DA/VID along the trunk path. Commonly, two trunks are formed along the same path through the network in two different directions, so that traffic may be transmitted between the nodes at the ends of the path in both directions. A network management system 108 may be used to create the trunks, although other ways of defining trunks and causing the trunks to be established may be used as well.

In a PBT network, when a trunk 106 is to be established, the network elements install forwarding state for the trunk so that traffic on the trunk will be forwarded along the defined path. For example, in the illustrated network, a pair of PBT trunks (106A, 106B) extend between network element A and network element D. Intermediate nodes (network elements B and C) will install forwarding state to implement the trunk. Traffic on the trunk is identified using the MAC address of the trunk endpoint (Destination MAC address or DA) and the VPN ID (VID). The combination of DA and VID uniquely identifies the destination and the flow, so that different traffic intended for the DA may follow different paths through the network. Additionally, the combination of DA/VID may be expected to be unique and, accordingly, may be used by the dataplane of the intermediate nodes to identify traffic and forward traffic on the trunk without requiring additional labels to be applied to the traffic.

According to an embodiment of the invention, an Ethernet OAM frame addressed to a PBT trunk endpoint is configured to indicate to the intermediate nodes on the PBT trunk that the OAM frame is to be used to implement an intermediate node OAM function on one or more of the intermediate nodes on the PBT trunk. As discussed below, the indicia may be implemented in the form of an EtherType, OpCode, TLV, or in another field of the Ethernet frame.

Ethernet OAM may be used to implement loopback, linktrace, Alarm Indication Signals (AIS) and other conventional OAM. Although the following several examples will focus on the use of specific OAM frames to implement loopback and linktrace, the invention is not limited in this manner as the OAM frames may be used to implement the other OAM functions as well.

FIGS. 1B and 1C illustrate several different forms of OAM functions that may be implemented using the OAM frames described in greater detail below. Specifically, FIG. 1B illustrates an embodiment in which the OAM frame is used to implement a loopback OAM function at intermediate node C. In this embodiment, when the intermediate node C receives an intermediate node OAM message on trunk 106A, it generates a reply OAM message 108 and transmits the reply back to source node A over reply reverse trunk 106B. Loopback, as is well known, causes a particular node to respond to the OAM message and thus is able to poll a particular network element on a path through the network.

FIG. 1C is similar to FIG. 1B, except that the OAM function to be performed is linktrace. For example, as shown in FIG. 1C, it will be assumed that a linktrace is to be performed between nodes A and C. As the OAM frame is transmitted along trunk 106A, each intermediate node that receives the OAM frame will generate a reply 108 and transmit the reply back to source node A on reverse trunk 106B. Thus, in this example, intermediate nodes B and C would both generate a reply message 108.

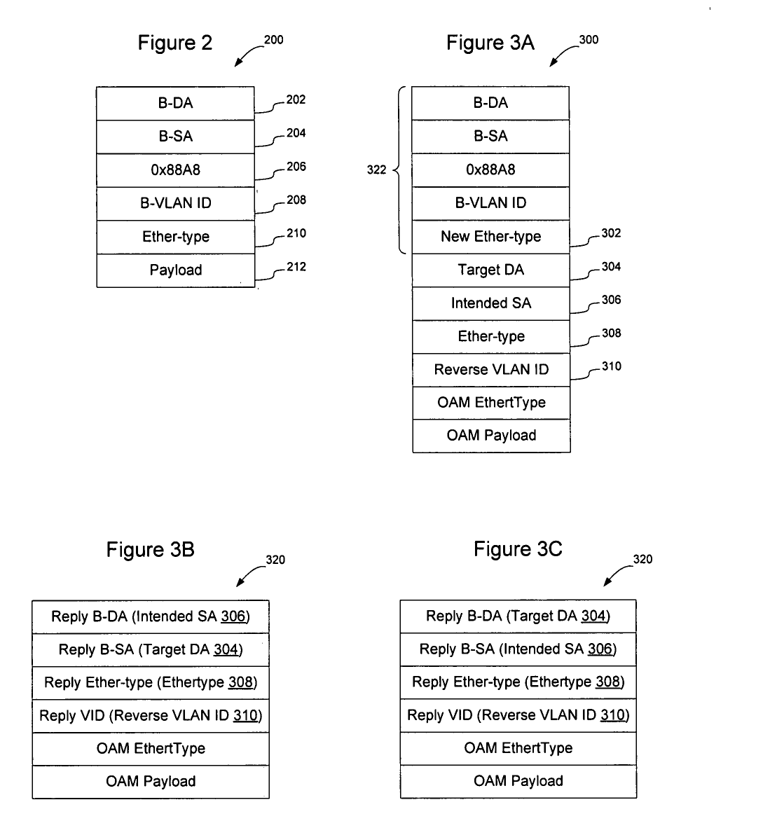

FIG. 2 illustrates an Ethernet frame 200. As shown in FIG. 2, an Ethernet frame generally includes a destination MAC address (B-DA) 202 and a source MAC address (B-SA) 204. The source and destination MAC addresses in the Ethernet network of FIG. 1 are backbone (B) MAC addresses of the network elements 102, which is generally the provider addressing space.

The OAM frame includes an EtherType field 206 which, in the illustrated example, is 0x88A8. The Ethernet frame also includes a B-VLAN ID (VID) field 208 which is used to identify which type of VLAN the frame relates to. This tag is a provider implemented tag, also known as the Q-tag, that enables the network elements 102 in the Ethernet network to identify the VLAN associated with the frame without inspecting the other portions of the frame for client specified tags. The OAM frame will be forwarded on the PBT trunk in a normal manner, since the OAM frame contains the expected DA/VID used to forward traffic on the PBT trunk.

The Ethernet frame 200 also includes a second Ether-type 210 that indicates to the dataplane of a network element handling the frame what type of frame it is. For example, the EtherType field 210 may contain a value indicating that a frame is a data frame, a control frame, or, according to an embodiment of the invention, an Ethernet OAM frame intended to be used by intermediate node s on the PBT trunk to implement an OAM function on the trunk. Other values may be included in the EtherType field 210 as well to implement other known functions.

FIG. 3 illustrates another embodiment of an Ethernet frame that may be used to implement Ethernet OAM at an intermediate node on a PBT trunk. As shown in FIG. 3, the Ethernet frame 300 includes a new Ether-type value 302 that is recognizable by intermediate switches 102 as indicating that the frame is a OAM frame.

The Ether-type 302 enables intermediate nodes to pick up OAM frames potentially targeted at them. When an intermediate node receives a frame with the Ether-type value 302 set to a value indicating that the frame is an intermediate node OAM frame, the intermediate node will look at other fields in the OAM frame to determine if further action is required in connection with the OAM frame.

In the example shown in FIG. 3, the OAM frame includes a target destination address (DA) 304 that allows the fastpath (data plane of the Ethernet switch) to identify whether the OAM frame is addressed to the particular intermediate node. The target DA will be an individual MAC address where the OAM frame is to be used to implement a loopback function at a particular intermediate node, or may be a group MAC address where the OAM frame is to be used to implement a linktrace function. Note in this regard that loopback causes a particular node to reply to receipt of a particular frame whereas link trace causes all intermediate nodes along a particular path to respond to receipt of the particular frame.

The OAM frame also includes the intended Source Address (SA) 306 which enables OAM reply frames to be directed to a source address of the OAM frame when the OAM frame was not generated by the PBT trunk endpoint. Generally, where the OAM frames are to be sent back to the source of the PBT trunk the intended SA 306 will be the same as the Backbone Source Address (B-SA) 204. However, by enabling the OAM frame to carry a field containing the intended SA, the OAM frames are not automatically required to be sent back to the source of the PBT trunk.

The OAM frame may also include an Ether-type value 308 that may be used to identify the type of OAM function to be implemented by the intermediate network element. This field allows the intermediate node to issue a reply frame by removing the header 322 in FIG. 3A from the received OAM frame and the resultant frame is a valid reply frame. This field may be eliminated, if desired, where the EtherType value 302 is sufficiently specific to convey this information. For example, if a different Ether-type value is specified for each of the OAM functions, the second Ether-type field 308 may be redundant.

The OAM frame also includes a reverse VLAN ID field 310 in which the reverse VLAN may be carried. The reverse VLAN ID (VID) is used in connection with the intended SA (or the B-SA where the OAM frame originated at the trunk endpoint) to address reply frames. For example, as shown in FIG. 1, frames on the trunk 106a from A to D would be addressed to network element D using the DA of network element D and a first VID. The combination of the DA and VID is used to identify frames on the trunk 106a from A to D. In the reverse trunk, from network element D to network element A, frames will be identified by the destination MAC address of network element A, which may be the B-SA or alternatively the intended SA 306 of the frame shown in FIG. 3. Since the intermediate nodes B and C don't maintain a correlation between trunks 106a and 106b, the intermediate nodes need the reverse VLAN ID (e.g. the VID of reverse trunk 106b) to transmit a reply message on reverse trunk 106b. To enable the intermediate node to know the VID of the reverse trunk, the reverse VLAN ID field 310 may be used to carry this information so that the intermediate node does not need to maintain a correlation between forward and reverse trunks.

FIGS. 3B and 3C illustrate embodiments of reply frames that may be generated or created by an intermediate node according to embodiments of the invention. In the embodiment shown in FIG. 3B, the reply frame is created by using the value carried in the intended SA field of the OAM frame and using that address value as the reply B-DA. The target DA 304 of the OAM frame is used as the reply B-SA as discussed above. The Ether-type value may be taken from the Ether-type field 308 of the OAM frame and the reply VID is obtained from the Reverse VLAN ID field 310 of the OAM frame. The OAM payload may optionally be included as well.

FIG. 3C illustrates an alternate embodiment in which the reply OAM message is formed by simply removing a portion of the header of the OAM frame and transmitting the thus created new reply frame on the reverse PBT trunk. Specifically, as shown in FIG. 3C, if the manner in which the Target DA field 304 and the intended SA field 306 are changed slightly, an intermediate node may simply strip off fields 322 (B-DA 314, B-SA 316, Ethertype 318, B-VLAN ID 320, and New Ether-type fields 302), to create the reply frame. In this embodiment, the target DA field 304 is used to carry the destination address of the source of the OAM where the reply message is to be sent. The reverse VLAN ID is the VID of the reverse trunk 106b which enables the reply frame to be carried on the reverse trunk. The intended source address field 306, of this embodiment, is the MAC address of the intermediate node that is performing the OAM function and is used as the reply message B-SA field. The ethertype field 308 is provided, in this embodiment, in the original OAM frame to enable the reply OAM frame to appear as a regular Ethernet frame without requiring the intermediate node to do any processing other than to remove the initial several fields of the original OAM frame. Thus, in this example, the Ethertype field 308 may be set to 0x88A8 to enable the reply OAM frame to have this Ethertype. Other Ethertypes may be used as desired in connection with a particular implementation.

In the embodiment shown in FIG. 3C, the source of the OAM frame essentially creates a reply OAM frame and encapsulates the reply OAM frame with an Ethernet header having a new Ethertype value. The new Ethertype value enables the intermediate nodes on the PBT trunk to identify the frame as an intermediate node OAM frame. To reply to the OAM frame, the nodes may simply remove the encapsulating header fields 322 and transmit the resultant unencapsulated reply OAM frame on the reverse path 106b. This enables. the intermediate node to create the reply frame in hardware without requiring the node control plane to process the frame.

Although the embodiment shown in FIG. 3C has been described in the context of implementation of an OAM function by transmitting a OAM Frame with the intended reply frame embedded therein, this embodiment of the invention may be used to perform other functions as well. Specifically, the notion of embedding a frame into an Ethernet message to be transmitted by a node on the Ethernet network may be used to implement many functions other than OAM related functions. Essentially, this embodiment includes a Mac-in-Mac encapsulated reply frame, in which both the inner MAC header and the outer MAC header are created using provider (B) MAC addressing space so that both the original and the reply frames may be transported on the provider network. Although this may be used to implement OAM functions, since reply frames are often used in connection with implementation of OAM functions, the invention is not limited in this manner as it may be used in other contexts to enable one network element to cause another network element to transmit a frame on the same network.

Although use of a new EtherType to enable OAM functionality may be advantageous, the invention is not limited to this embodiment and other ways of implementing OAM functionality on intermediate nodes may be used as well. Two additional embodiments are described in connection with FIGS. 4-5 and 6-7.

In the embodiment shown in FIGS. 4-5, the intermediate nodes are alerted that an Ethernet frame is an OAM frame intended for one or more of the intermediate nodes on a PBT trunk by using the Ethernet frame OpCode field. The Ethernet standard defines many different operational codes (OpCodes) that may be used to specify different types of processing to be performed on the frames by network elements on the Ethernet network. According to an embodiment of the invention, one or more OpCodes may be defined to implement OAM functionality so that, by inspecting the OpCode field(s) of a received frame, a network element may determine whether the frame is a OAM frame intended for an intermediate node on the PBT trunk and, if so, how the OAM frame should be handled.

OpCode field values are assigned by the Institute of Electrical and Electronics Engineers (IEEE) once agreement ahs been reached as to how network elements should handle frames with the particular OpCodes. Once an OpCode has been assigned, the functionality associated with the OpCode is set, all vendors that comply with the standard will treat frames with the defined OpCode in the same manner. There are currently many OpCodes assigned to implement particular functions and optionally, one or more OpCodes may be assigned to implement OAM functionality on intermediate nodes in a PBT network. Similarly, the IEEE also assigns EtherType values (discussed above in connection with FIGS. 2-3) and TLV values (discussed below in connection with FIGS. 6-7). One or more specific values may be assigned by the IEEE for use in connection with implementing intermediate node OAM functionality on a PBT trunk.

One of the OpCodes that has already been assigned is a vendor specific OpCode that enables vendors to specify to all other network elements on the network that a frame has been formatted in a special way that is specific to the particular vendor. In the current version of the standard, OpCode 51 is used to specify that the frame is formatted according to a particular vendor's format. By causing the source of the OAM frame to set the OpCode of the OAM frame to “51”, OAM functionality may be implemented on network elements associated with a particular network equipment vendor. If the standards body adopts one or more intermediate node OAM values, all network equipment vendors will be required to implement the OpCode the same way and, accordingly, the OAM functionality will work regardless of which vendor manufactured the network element.

Since the standards process has not been completed, and one or more OpCode values have not been assigned to implement OAM functionality, an embodiment will be described in which the vendor specific OpCode of 51 is used to implement OAM functionality. Since some of the fields may not be required if the standardization process completes, the invention is not limited to this particular implementation. As shown in FIG. 4, after the OAM ether-type field 210, which indicates to the network element that this is an OAM frame, the Ethernet frame includes a Maintenance Level field (MEL) 402 and a versions field 404 indicating which version of the standard is being implemented. OpCode field 406, described above, is next and, in this embodiment, has been set to “51” which indicates to network elements on the network that the OAM frame has been formatted in a vendor specific manner. If the standards body adopts different OpCode values this field may change from value “51” to the value adopted by the standards body. Additionally, depending on the manner in which this is implemented, several other fields that will be discussed below may become obsolete and/or reordered.

The OpCode value is followed, in this embodiment, by one or more flags that may be used to indicate one or more vendor specific aspects. The invention is not limited to the manner in which the flags are used or to the inclusion of a flags field 408.

The flags field is followed by a Type Length Value (TLV) offset field which indicates the start of the vendor specific fields.

As noted above, OpCode value 51 indicates that the OAM frame is formatted in a vendor specific manner. To enable the network elements to determine whether the OAM frame may be understood by that network element, the TLV offset field is followed by an Organizationally Unique Identifier (OUI) value that identifies the vendor that is able to read the frame format. Thus, when a OAM frame with an OpCode=51 is received, the network element will look at the OUI field 412 to determine if the OAM frame is associated with the same vendor as the network element. If so, the network element will look at a sub-OpCode field 414 to determine what OAM functionality is to be implemented in connection with the OAM frame. For example, if a network element manufactured by Nortel Networks received a OAM frame with OpCode field=51, it would look to determine if the OUI field contained the Nortel Networks OUI. If so, it would look at the sub-OpCode field 414 to determine what type of OAM function was to be performed. If the OUI field did not match the Nortel Networks OUI, the frame would be handled in a standard manner and the remaining vendor specific fields would be ignored.

The OAM frame shown in FIGS. 4-5 also includes several fields that are similar to the embodiment shown in FIG. 3. Specifically, after the sub-OpCode field 414, the OAM frame includes the target DA, which is used to identify one or more of the intermediate nodes on the PBT trunk, the intended SA which is the source MAC address of the node where the reply should be sent, the reverse VLAN ID field that is used to place the reply on the reverse trunk 106b. These fields are the same as those described above in connection with FIGS. 2-3. The OAM frame may also include one or more additional fields depending on the implementation and optionally may include an end TLV. The particular order of the frames may be optimized according to the particular hardware that will be used to implement the OAM functions and, accordingly, the invention is not limited to the particular order described above in connection with FIGS. 4-5. Similarly, one or more of the described fields may be omitted if desired or several of the fields may be merged depending on the particular way in which OpCodes are used to implement the OAM functionality. Once standardized, for example, it may be expected that the need for the OUI field 412 would be reduced.

FIGS. 4B and 5B illustrate an embodiment of the invention in which a standardized OpCode value is used to implement OAM functionality on an intermediate node on a PBT trunk. As shown in FIG. 4B, although some of the fields are the same, the OAM frame shown in FIG. 4B is different than the frame shown in FIG. 4A in that the OpCode value 406 has been changed from vendor specific value 51 to another value X. The particular number selected by the standards body is irrelevant. Also, since all network elements that implement the standard will process the frame in the same way, the OAM frame does not need to include the organization OUI field 412. Similarly, the OAM frame does not need to include the Sub-OpCode field 414, although that may be retained if configured to specify the type of OAM function to be performed by the intermediate node.

A reply frame may be created by removing all fields up to the Target DA field of the OAM frame and then using the target DA, intended SA, reverse VLAN ID, and other fields as a reply OAM frame, as discussed in greater detail above in connection with FIG. 3C. Alternatively, a reply frame may be constructed from values contained in the original OAM frame and/or known to the intermediate node, as described in greater detail above in connection with FIG. 3B.

FIGS. 6-7 illustrate another embodiment of the invention in which a Type Length Value (TLV) is used to implement intermediate OAM in a PBT network. As shown in FIGS. 6-7, an Ethernet OAM frame may be formatted using a standardized OpCode such as an OpCode indicating that the frame is an OAM loopback message. While these OAM messages work well in an ordinary Ethernet network, when PBT is being implemented the intermediate network elements may not be able to respond to these OAM messages as described in greater detail above. According to an embodiment of the invention, the TLV fields of the Ethernet frame may be used to specify either an organizationally specific TLV (FIGS. 6A and 7A) or a standardized TLV (FIGS. 6B and 7B) that may be used to implement intermediate OAM in a PBT network.

There are many TLV values that have been allocated by the standards body to implement particular functions. According to an embodiment of the invention, one or more new TLVs may be allocated to implement OAM functionality at intermediate nodes on a PBT trunk in a PBT network. For example, a TLV value may be allocated to indicate that the OAM frame is intended for one or more intermediate nodes. Alternatively, the TLV value may also be used to implement OAM functionality at the end nodes as well, so that the same frame format is able to be used to perform OAM on the entire PBT trunk. One or more fields (such as the OpCode field) within the Ethernet frame in this embodiment may then be used to specify the type of OAM function (such as loopback, traceroute, link trace, AIS, etc.) to be performed by the intermediate node. Alternatively, several TLV values may be allocated to indicate particular types of intermediate OAM function that is to be performed by the intermediate node.

Until the standards body has decided on whether one or more specific TLVs should be allocated to implement intermediate node OAM in a PBT network, the vendor specific TLV of 31 may be used as shown in FIGS. 6A and 7A. When the TLV field 602 is set to 31, network elements receiving the frame will determine that the frame format is specific to the particular vendor identified by an organization OUI field 606. Upon receipt of a OAM frame having the vendor specific TLV field 602 set to “31” the network element will look at the organization OUI field 606 to determine if the value of the OUI field matches the identifier of the network element. If so, it will process the frame according to the format established by the network equipment vendor. If not, it will ignore the TLV fields and process the OAM frame as a standard OAM frame.

One embodiment of a vendor specific format will be described in connection with FIGS. 6-7. The invention is not limited to this example as other vendor specific or IEEE sanctioned formats may be used as well. In the embodiment shown in FIG. 6, the TLV fields include a length field 604 indicating the length of the TLV fields, vendor OUI field 606, and a sub-type field 608 indicating the type of OAM function to be performed. The OAM frame also includes the intended SA 610, target DA 612, and reverse VLAN ID fields 614 which are the same as those described above in connection with earlier embodiments. The OAM frame may also include one or more other TLVs, any desired additional fields 616, and an end TLV field depending on the particular implementation.

As shown in FIGS. 6B and 7B, if the standards body determines that one or more TLV values should be allocated to OAM, the TLV value of field 602 will be set to the standards-appropriated value which will alleviate the need to include OUI field 606 and optionally the sub-type field 608. Other format may be used as well, and the invention is not limited to the particular examples shown in the figures.

FIG. 8 illustrates a flow chart of a process that may be used to implement an embodiment of the invention. As shown in FIG. 8, when an intermediate node receives a OAM frame addressed with the DA/VID of the PBT trunk (800) there are two ways for the network element to process the frame. Specifically, the network element may have the hardware of the dataplane configured to look for particular values set at particular locations in the frame that will indicate to the network element that this is a OAM frame intended for that network element (802). The hardware that handles frames in the network element may include a network processor, ASICs, FPGAs, and other programmable hardware, and will be referred to herein as the “fastpath.”

Alternatively, the network element may forward OAM frames to a control process such as Ethernet OAM process 920 (discussed below in connection with FIG. 9) that is implemented in software and instantiated in a processor such as CPU 904 (804). When the OAM frame is forwarded to the control process, the control process may make further determinations as to the type of function to be implemented.

The OAM frame may be formatted using one of the formats described above or another alternative format to enable the intermediate nodes to recognize the frame as a OAM frame and to further recognize that the OAM frame is intended to be used by one or more of the intermediate nodes. Specifically, the OAM frame may contain a special EtherType value as described in connection with FIGS. 2-3, a special or vendor specific OpCode as described in connection with FIGS. 4-5 or a special or vendor specific TLV as described in connection with FIGS. 6-7. Combinations of Ethertype, OpCode, and TLV may also be used and the invention is not limited to an implementation in which only one of these techniques is used.

Regardless of how the OAM frame is detected, there are several ways for the intermediate node to reply to the OAM frame if required. For example, as discussed in connection with FIG. 3C, the network element may strip off the outer header fields and use the resultant frame as the reply frame (806). This may be implemented by either the fastpath or the control process, but is particularly suited for implementation in hardware since little processing is required to be performed by the intermediate node to form the reply frame.

Alternatively, the reply frame may be created, for example as described above in connection with FIG. 3B (808). Creation of the frame may be performed by the software process or in another manner by causing the fastpath to extract portions of the OAM frame and rearrange them to create the reply frame.

Once the reply frame has been formed or created, the intermediate node will transmit the reply frame (810), which will be addressed using the DA and VID of the reverse trunk. Depending on the type of OAM frame, the intermediate node may also forward the OAM frame on the trunk to other intermediate nodes on the path to the destination if necessary. For example, where the frame is a loopback frame and not addressed to the intermediate node that has received it, no reply is necessary by that intermediate node and the node will simply forward the OAM frame over the PBT trunk. Where the OAM frame is intended to be used to perform a loopback OAM function at the intermediate node, only this network element will be require to reply to the loopback frame and, accordingly, the OAM frame is not required to be forwarded on the PBT trunk. Other functions such as link trace may require all or a larger number of intermediate nodes on the network to generate reply frames and, accordingly, a determination as to whether the OAM frame should be forwarded on the PBT trunk may depend on the type of OAM function to be performed, which intermediate nodes are required to respond to the OAM frame, and other factors.

To handle OAM frames on the network, an intermediate node will need to determine (1) whether the frame is addressed to the intermediate node, and (2) what type of OAM function is being implemented. These two processes may both be performed at the same time if the fastpath is used since the fastpath is capable of reading multiple fields of an Ethernet frame. Alternatively the two processes may be performed serially, such as by having the fastpath forward all OAM frames to a control process for further evaluation. The invention is not limited by the particular implementation as other ways of implementing embodiments of the invention may be used as well.

FIG. 9 illustrates a functional block diagram of a network element that may be used to implement an embodiment of the invention. In general, the methods described herein may be implemented in network elements such as Ethernet switches, bridges, hubs, and other network elements configured to implement PBT functionality on an Ethernet network. The invention is thus not limited to the embodiment shown in FIG. 9 or to a particular network element but rather may be implemented in any network element regardless of the network element architecture.

In the embodiment shown in FIG. 9, the network element 102 includes a data plane 900 configured to handle data on the network in an efficient manner, for example to implement the fastpath described above. Many different dataplane architectures have been developed over the years, and the invention is not limited to any particular dataplane architecture. Thus, although FIG. 9 shows one example of a network element including a particular dataplane architecture, the invention is not limited to the illustrated embodiment as many differently configured Ethernet switches, bridges, nodes, etc., may be used to implement embodiments of the invention.

The dataplane 900 of the example network element shown in FIG. 9 includes a plurality of input/output cards 902. The input/output cards 902 generally contain the physical ports that are interfaced to optical fibers, copper wires, antennas, etc., that will implement the links 104 on the network 100. The input/output cards 902 may also contain processing circuitry configured to construct frames and perform other common line processing functions.

The dataplane 900 also includes a plurality of data service cards 904 which, in the illustrated embodiment, include one or more CPUs 906 and one or more network processing units (NPUs) 908. The NPUs 908 implement the fastpath 910 and also implement a forwarding information base 912 containing forwarding state for the PBT trunks. The CPU 906 may contain a FIB agent 914 configured to program changes in forwarding state into the FIB which may be used, for example, to cause new state information to be inserted into the FIB when a new PBT trunk is created and to cause old state information to be deleted from the FIB when a PBT trunk is torn down. The CPU may also have numerous other programs instantiated thereon and the invention is not limited by the manner in which the CPU is used on the network element.

The dataplane 900 also includes, in this embodiment, a switch fabric 916 configured to switch frames or packets of data between data service cards. The data service cards may process the frames before and/or after being sent to the switch fabric.

The network element 12 further includes a control plane 920 configured to specify the manner in which the data plane operates. The control plane of the network element interacts with the control plane of the communication network. Specifically, the control plane of the network element configures the data plane to cause particular actions to occur in the network element, whereas the control plane of the network itself enables the network elements to handle traffic.

In the embodiment shown in FIG. 9, the control plane 920 includes a processor 922 containing control logic 924 configured to load data and instructions from memory 926 that will enable the control logic to be configured to perform the functions described herein in connection with FIGS. 1-8.

For example, the memory 926 may have stored therein routing software 928 configured to implement a link state protocol or other type of routing protocol to exchange routing information with other network elements.

PBT software 930 is included in memory 908 to enable PBT trunks to be created on the network. The PBT software interfaces with the control plane of the network to receive PBT trunk setup messages and to determine whether state should be installed for trunks based on shortest path calculations. Specifically, when the network element receives a PBT trunk setup message, the network element will determine whether it is required to install forwarding state for the PBT trunk and, if so, cause the FIB agent 914 to install appropriate state in the FIB 912. Determination as to whether installation of state is required may depend on the manner in which the PBT trunk is created and signaled on the network.

The memory 926 may also include a replication 932 of the information contained in FIB 912 so that processes operating on the CPU can determine quickly what type of information is already installed in the FIB.

The network element may also implement a protocol stack 934 configured to enable the network element to implement the Ethernet protocol and other protocols on the network. Coupled with this is Ethernet OAM software 936 configured to implement the OAM functions described herein. For example, the Ethernet OAM software may be configured to enable reply frames to be created and transmitted by the network element in response to received OAM frames. In operation, the dataplane will be configured to recognize Ethernet OAM frames that are intended to be used to perform intermediate node OAM functions on the PBT trunks. When a OAM frame is identified, the data plane may itself form a reply, or it may pass the OAM frame to one or more processes in the CPU 906 or processor 922 in the control plane 920. For example, the OAM frame may be passed to Ethernet OAM software 936 for processing. If the OAM frame is passed to the Ethernet OAM software 936, the relevant information will be extracted from the OAM frame and a reply frame will be created (if necessary) that will then be passed to the data plane for transmission on the reverse PBT trunk.

The functions described above may be implemented as a set of program instructions that are stored in a computer readable memory within the network element and executed on one or more processors within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of implementing Ethernet OAM at an intermediate node in a Provider Bridged Transport (PBT) network, the method comprising the steps of:
receiving by an intermediate network element on a PBT trunk in an Ethernet network a OAM frame addressed to an endpoint of the PBT trunk but containing an indicia that the OAM frame is intended to be used to perform an intermediate node OAM function; and
generating a reply message by the intermediate node based on information contained within the OAM frame.

2. The method of claim 1, wherein the OAM frame further comprises an indication of the type of OAM function to be performed.

3. The method of claim 1, wherein the OAM frame comprises a target MAC address field configured to carry information to enable the intermediate nodes on the PBT trunk to determine whether the OAM frame is intended for the intermediate node or another intermediate node on the PBT trunk.

4. The method of claim 1, further comprising the step of determining, by the intermediate node, whether a response is required to the OAM frame, and wherein the step of generating a reply message is performed if a response is required.

5. The method of claim 4, wherein the step of determining comprises evaluating a target destination address field of the OAM frame to determine if the OAM frame contains a MAC address of the intermediate node in the target destination address field.

6. The method of claim 1, wherein the intermediate node doesn't maintain correlation information between the PBT trunk and a reverse PBT trunk, and wherein the OAM frame contains reverse trunk information to enable the intermediate node to generate the reply message for transmission over the reverse PBT trunk.

7. The method of claim 6, wherein the reverse trunk information comprises a VLAN ID of the reverse PBT trunk, wherein reply message is a reply OAM frame, and wherein the method further comprises the step of transmitting the reply OAM frame over the reverse PBT trunk.

8. The method of claim 1, wherein the intermediate node maintains correlation information between the PBT trunk and a reverse PBT trunk, wherein reply message is a reply OAM frame, and wherein the method further comprises the step of transmitting the reply OAM frame over the reverse PBT trunk.

9. The method of claim 1, wherein the OAM frame contains an embedded reply frame, and wherein the step of generating the reply message comprises extracting the embedded reply frame.

10. The method of claim 1, wherein the OAM frame comprises an Ethernet Header for the PBT trunk and an embedded Ethernet frame for use as the reply message, and wherein the step of generating the reply message comprises stripping of the Ethernet header for the PBT trunk, the method further comprising the step of transmitting the reply message over a reverse PBT trunk.

11. The method of claim 1, wherein the indicia contained in the OAM frame is an Ethertype value indicating that the OAM frame is intended to be used to perform the OAM function at the intermediate node.

12. The method of claim 1 1, wherein the Ethertype value is an OAM Ethertype.

13. The method of claim 1, wherein the indicia contained in the OAM frame includes a combination of a vendor specific OpCode value coupled with an organization identifier and a sub-opcode indicating to network elements associated with a manufacturer that the OAM frame is intended to be used to perform an intermediate node OAM function by network elements associated with that manufacturer.

14. The method of claim 1, wherein the indicia contained in the OAM frame is an OpCode value indicating that the OAM frame is intended to be used to perform the OAM function at the intermediate node.

15. The method of claim 1, wherein the indicia contained in the OAM frame is a combination of a vendor specific TLV value coupled with an organization identifier and a sub-type value configured to be used to perform the intermediate node OAM function by network elements associated with a manufacturer identified by the organization identifier.

16. The method of claim 1, wherein the indicia contained in the OAM frame is a TLV value indicating that the OAM frame is intended to be used to perform the OAM function at the intermediate node.

17. The method of claim 1, wherein the indicia contained in the OAM frame comprises comprising a combination of two or more values, the values being selected from an OAM EtherType, an OAM OpCode, and an OAM TLV, wherein the combination of the values is configured to indicate that the OAM frame is required to be processed at an intermediate node other than at a destination address of the OAM frame.

18. A method of implementing Ethernet OAM at an intermediate node in a Provider Bridged Transport (PBT) network, the method comprising the steps of:
receiving by an intermediate network element on a PBT trunk in an Ethernet network a OAM frame addressed to an endpoint of the PBT trunk but containing an indicia that the OAM frame is intended to be used to perform an intermediate node OAM function; and
determining, by the intermediate network element, whether a response is required to the OAM frame.

19. An Ethernet frame, comprising:
an Ethernet header containing a destination MAC address (DA) and a VLAN Identifier (VID) configured to enable the Ethernet frame to be transported along a Provider Bridged Transport (PBT) trunk through an Ethernet network, the PBT trunk being defined by installing forwarding state associated with the DA/VID in network elements on the Ethernet network along a path through the Ethernet network; and
at least one of:
an Ethertype value indicating that the Ethernet frame is an OAM frame;
an OpCode value or a combination of an organization specific OpCode value and one or more sub-field values indicating that the Ethernet frame is an OAM frame; and
a TLV value or a combination of an organization specific TLV value and one or more sub-field values indicating that the Ethernet frame is an OAM frame.

20. The Ethernet frame of claim 19, further comprising a plurality of fields that may be used to generate the reply message, the plurality of fields comprise at least a first field containing a destination MAC address of a reply PBT trunk and a second field containing a reverse VLAN ID associated with the reply PBT trunk.
